(19) United States
(12) Patent Application Publication
(10) Pub. No.: US 2015/0232190 A1
(43) Pub. Date: Aug. 20, 2015

(54) ATTACHMENT DEVICE FOR THERMAL PROTECTION PANEL

(71) Applicant: AIRCELLE, GONFREVILLE L'ORCHER (FR)

(72) Inventor: Fabrice PROVOST, Notre-Dame-de-Bec (FR)

(21) Appl. No.: 14/704,285

(22) Filed: May 5, 2015

Related U.S. Application Data
(63) Continuation of application No. PCT/FR2013/052729, filed on Nov. 13, 2013.

(30) Foreign Application Priority Data
Nov. 13, 2012 (FR) 12/60771

(51) Int. Cl. B64D 29/06

(52) U.S. Cl. CPC B64D 29/06

(57) ABSTRACT

The present disclosure relates to an attachment device for a thermal protection panel, including an attachment base providing the attachment to a stationary structure that receives the panel, and that is provided with a fastening structure capable of penetrating a corresponding through-opening of the panel to be attached in order to engage with a corresponding retainer associated with a complementary retaining button. In particular, the fastening structure extends over a length greater than the thickness of the panel to be attached, such as to project from same, and the device includes an intermediate spacer arranged between the panel and the retaining button, and having a through-opening which the projecting portion of the fastening structure is capable of partially penetrating in order to engage with the means for retaining the button.

### CROSS-REFERENCE TO RELATED APPLICATIONS

This application is a continuation of International Application No. PCT/FR2013/052729, filed on Nov. 13, 2013, which claims the benefit of FR 12/60771, filed on Nov. 13, 2012. The disclosures of the above applications are incorporated herein by reference.

### FIELD

The present disclosure relates to a device for attaching a thermal protection mat onto an internal fixed structure of a turbojet engine nacelle.

### BACKGROUND

The statements in this section merely provide background information related to the present disclosure and may not constitute prior art.

An aircraft is moved by one or several turbojet engines each housed in a nacelle.

A nacelle generally has a substantially tubular structure comprising an air inlet upstream of the turbojet engine, an intermediary assembly intended to surround a turbojet engine fan and a rear assembly capable of integrating thrust reversal means and intended to surround the combustion chamber and all or part of the compressor stages and turbojet engine turbine, and is generally terminated by an ejection nozzle of which the outlet is located downstream of the turbojet engine.

Modern nacelles are intended to accommodate a dual flow turbojet engine capable of generating, on the one hand, a hot air flow (also called primary flow) from the combustion chamber of the turbojet engine and circulating in a space delimited by a compartment of substantially tubular shape called “core” compartment, and on the other hand, a cold air flow (called secondary flow) from the fan and circulating outside the turbojet engine through an annular passage, also called stream, formed between an inner structure defining a turbojet engine fairing and an inner wall of the nacelle. The two air flows are ejected from the turbojet engine from the rear of the nacelle.

The “core” compartment comprises an outer envelope serving as casing and called internal fixed structure (IFS).

This internal fixed structure is subjected to strong thermal constraints and it is necessary to protect it by means of thermal protection panels, allowing in particular to isolate the components of the nacelle from the engine environment in order to maintain them at acceptable temperatures and prolong their life.

These thermal protection mats also provide a protection against fire and may be used in other areas of the nacelle at which a fire hazard exists.

In order to thermally protect the IFS, it is known to resort to protection panels placed on the “core” compartment side, and comprising at least an insulating mat, generally manufactured from fibers of silica, ceramic or a microporous material, said mat being taken between sheets which are usually in stainless steel.

The thermal protection mats are attached to the IFS by means of attachment systems which cooperate locally with it over the entire protection surface like rivets.

The thermal protection is also retained by its edges on the IFS by retaining strips usually called “retainers”.

An example of attachment system according to the prior art is described in document FR 2 829 811.

Such an attachment system uses a safety wire system and generally comprises two parts, namely, on the one hand, a sub plate attached in the IFS and carrying a fastening structure (of hook, loop or eye bolt type for example) partially coming inside a corresponding attachment orifice in the mat and able to receive a safety wire, and on the other hand, a retaining button bearing against an external surface of the mat in such a manner as to form a maintaining and clamping washer, said retaining button being provided with orifices for the passage of the safety wire which is then twisted and clamped.

Retaining the panel on the IFS is thus provided.

In order to perfect the protection, the twisted end of the safety wire is then laid in silicone.

Alternatively, the safety wire system may be replaced by a threaded or tapped fastening structure cooperating with a complementary end of the retaining button. However, such screwed systems are heavy, are more expensive and are hardly efficient thermally-speaking.

In a general manner, placing these attachments takes an extremely long time and an important number of operations are necessary.

Due to the presence of the button bearing against the mat, the height of the fastening structure is limited to the thickness of the mat. Due to this fact, the eyelets or the hook of the fastening structure is located inside the corresponding orifice of the mat and is very difficult to pass the safety wire through. This requires a lot of time and precision on the part of the operators, and all the more so as this operation must be repeated for each attachment.

### SUMMARY

The present disclosure provides an attachment device for thermal protection panel comprising at least one attachment sub plate capable of providing the attachment thereof to a fixed structure intended to receive said panel, said attachment sub plate being equipped with at least one fastening structure capable of penetrating inside a corresponding through orifice of the panel to be attached in order to cooperate with a corresponding retaining means associated with at least one complementary retaining button, characterized in that the fastening structure extends over a length greater than the thickness of the thermal protection panel to be attached in such a manner as to protrude over the latter, and in that the device comprises at least one intermediate spacer intended to be disposed between the thermal protection panel and the retaining button and having a through orifice inside of which the protruding part of the fastening structure is capable of partially penetrating in order to cooperate with the retaining means of the button.

Thus, by providing a fastening structure protruding from the protection panel to be attached, the latter is more easily accessible to the operator for introducing thereto the corresponding retaining means, and it is no longer necessary to blindly proceed on a fastening structure which is partially buried inside the corresponding orifice of the mat.

The spacer then allows to serve as a complementary supporting structure for the button and compensates for this complementary height of the fastening structure.

The spacer also allows reinforcing the thermal performance of the currently used safety wire system.

According to one form, the retaining means of the button is a safety wire.

According to a first variant, the fastening structure of the retaining means is a hook.

According to a second variant, the fastening structure of the retaining means is an eye bolt forming loop for the safety wire.

According to a second form, the retaining means of the button is a tapped or threaded end piece.

According to a particular variant, the fastening structure is a complementary threaded/tapped bolt of the tapped/threaded end piece of the button.

In another form, the fastening structure extends along a direction which is substantially normal to the attachment sub plate and the corresponding attachment plane.

Advantageously, the attachment sub plate may be integrated in the fixed structure intended to receive the panel.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents a cross-sectional view of one form of an attachment device according to the present disclosure.

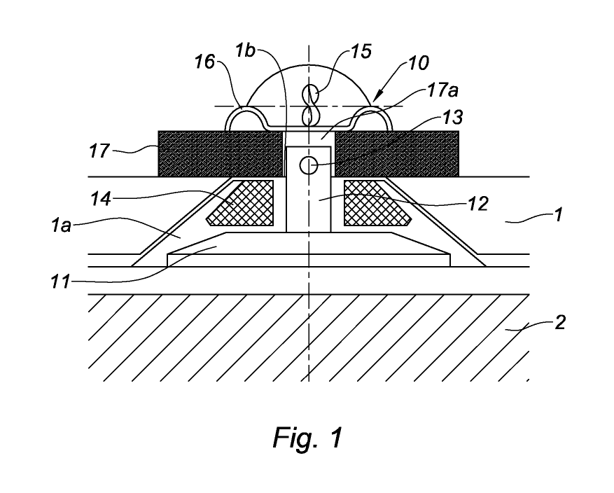

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As mentioned previously, the present disclosure relates to a fastening device 10 of a thermal protection panel 1 on a fixed structure 2.

The device comprises at least one attachment sub plate 11 capable of providing the attachment thereof to the fixed structure 2, for example by gluing and equipped with a fastening structure 12 having the shape of an eye bolt 13 extending along a direction which is substantially normal to the sub plate 11.

The thermal protection panel 1 covers the sub plate at a housing 1a of a substantially complementary shape preserved in the thickness of the panel 1.

A through orifice 1b located facing the fastening structure 12 allows the latter to cross the panel 1.

An insulating washer 14 provides the interface between the panel 1 and the sub plate 12.

In accordance with the present disclosure, the fastening structure 12 has a length which is sufficient for crossing the orifice 1b and protruding from the panel 1 in such a manner as to make the eyelet 13 accessible.

The fastening structure is intended to cooperate with a corresponding retaining means, in this instance a safety wire 15, associated with a retaining button 16.

Furthermore, the device comprises an intermediate spacer 17 intended to be disposed between the thermal protection panel 1 and the retaining button 16 and having the shape of a washer having a central orifice 17a capable of allowing the introduction of the fastening structure 12.

More particularly, during the placing of the device, the safety wire is introduced through the eyelet 13 of the fastening structure 12 and the ends thereof are introduced through two corresponding orifices (not visible) of the retaining button 16. The safety wire is then twisted in such a manner as to provide the clamping and the pressing of the retaining button 16.

In accordance with the present disclosure, the spacer 17 has a thickness greater than the height of the part of the fastening structure 12 protruding from the panel 1 in such a manner that this fastening structure only partially penetrates inside the orifice 17a. Thus, the retaining button is clamped against the spacer 17 which maintains the panel 1, while rendering the fastening structure more accessible when the device 10 is not clamped.

The safety wire is then laid in silicone like in the prior art.

Although the present disclosure has been described with a particular form example, it is obvious that is in no way limited thereto and that it comprises all the technical equivalents of the means described as well as their combinations if the latter enter within the scope of the present disclosure.

What is claimed is:

1. An attachment device for a thermal protection panel comprising at least one attachment sub plate capable of providing the attachment thereof to a fixed structure receiving the thermal protection panel, said at least one attachment sub plate being equipped with at least one fastening structure configured to penetrate inside a corresponding through orifice of the thermal protection panel to be attached in order to cooperate with a corresponding safety wire forming retaining means and associated with at least one complementary retaining button, wherein said at least one fastening structure extends over a length greater than a thickness of the thermal protection panel to be attached in such a manner as to protrude over the latter, and the attachment device comprises at least one intermediate spacer disposed between the thermal protection panel and the retaining button and having a through orifice inside of which the protruding part of the fastening structure partially penetrates in order to cooperate with the safety wire of the retaining button.

2. The device according to claim 1, wherein said at least one fastening structure of the retaining means is a hook.

3. The device according to claim 2, wherein said at least one fastening structure of the retaining means is a bolt with an eye forming a loop for the safety wire.

4. The device according to claim 1, wherein said at least one fastening structure extends along a direction which is substantially normal to said at least one attachment sub plate and a corresponding attachment plane.

5. The device according to claim 1, wherein said at least one attachment sub plate is integrated in the fixed structure to receive the thermal protection panel.
